(19) United States
(12) Patent Application Publication
(10) Pub. No.: US 2024/0296985 A1
(43) Pub. Date: Sep. 5, 2024

(54) COIL, ELECTRICAL SYSTEM INCLUDING THE SAME AND METHOD OF MAKING COIL

(71) Applicant: 3M INNOVATIVE PROPERTIES COMPANY, St. Paul, MN (US)

(72) Inventors: Jinwook Kim, Hwaseong-si (KR); Seong-Woo Woo, Gwangju-si (KR); Sang-Jun Mo, Suwon-si (KR); Dongeun Lee, Anyang-si (KR); Jong-Pil Kim, Gyeonggi-do (KR)

(21) Appl. No.: 18/578,425

(22) PCT Filed: Jul. 19, 2022
(86) PCT No.: PCT/IB2022/056649

§ 371 Date: Jan. 11, 2024

(30) Foreign Application Priority Data
Jul. 21, 2021 (KR) 10-2021-0095793

(51) Int. Cl. H01F 10/10; H01F 27/28; H02J 50/00; H02J 50/10

(52) U.S. Cl. CPC H01F 10/10; H01F 27/2847; H01F 27/2871; H02J 50/005; H02J 50/10; H01F 2027/2857

(57) ABSTRACT

The disclosure relates to a coil and an electrical system including the same. Specifically, according to an embodiment of the disclosure, there is provided a coil including: main coil surfaces which are opposite each other and are substantially planar; and a multilayer film which is wound to form a plurality of loops which are substantially concentric, wherein the plurality of loops include an innermost loop including a first longitudinal direction end of the coil, and an outermost loop including a second longitudinal direction end of the coil, wherein the multilayer film includes a plurality of first electro-conductive layers which alternate with each other, and one or more second electrical insulation layers, wherein the first electro-conductive layer and the second electrical insulation layer have a width and a length which are substantially coextensive therebetween, such that the main coil surfaces, which are substantially planar, include corresponding end surfaces of the first electro-conductive layer and the second electrical insulation layer, respectively, wherein at least two first electro-conductive layers have different average thicknesses to reduce an alternating current resistance of the coil by 5%-11.3% inclusive in a frequency of at least about 148 KHz.

### TECHNICAL FIELD

The disclosure relates to a coil, an electrical system including the same, and a method of making a coil.

### BACKGROUND

A portable electronic device having a battery embedded therein, such as a smartphone, a personal digital assistant (PDA), a tablet, or the like, needs to be charged with power. Recently, a system for wirelessly transmitting power is increasingly used to charge a battery embedded in a portable electronic device, etc. Such a wireless charging system (wireless power charging (WPC)) may transmit and receive power by using electromagnetic induction or resonance, and to achieve this, a coil is provided in an electronic device and a wireless charging system.

In addition, the portable electronic device may provide various functions such as a short-range wireless communication system (near field communication (NFC)) and a wireless electronic payment system (magnetic secure transmission (MST)), etc., as well as the wireless charging system. In particular, the portable electronic device may be provided with a plurality of coils in the electronic device in order to perform the short-range wireless communication and the wireless electronic payment system.

As described above, the portable electronic device may have a plurality of coils installed therein to perform the wireless charging system, the short-range wireless communication system, and the wireless electronic payment system, independently.

### SUMMARY

### Technical Problem

In a coil having a plurality of turns, a distribution of current flowing through a cross section of the coil is changed due to the proximity effect caused by an eddy current usually, and the current is changed to reduce an effective cross-sectional area allowing the current to flow in the coil. Since a related-art coil has a small effective cross-sectional area enabling a current to flow therethrough, the resistance of the coil increases compared to a direct-current resistance. In addition, since the effective cross-sectional area of the coil is abruptly reduced as an operating frequency is higher, a part of energy stored in the coil may be consumed as heat during wireless charging. To this end, efficiency of wireless charging through the coil may be reduced.

An embodiment of the disclosure has been invented based on the above-described background, and provides a coil and a wireless charging system which can reduce an alternating current resistance of a coil by increasing an effective cross-sectional area of a current flowing through the coil, and can enhance efficiency of wireless charging.

### Technical Solution

According to one aspect of the disclosure, there is provided a coil including: main coil surfaces which are opposite each other and are substantially planar; and a multilayer film which is wound to form a plurality of loops which are substantially concentric, wherein the plurality of loops include an innermost loop including a first longitudinal direction end of the coil, and an outermost loop including a second longitudinal direction end of the coil, wherein the multilayer film includes a plurality of first electro-conductive layers which alternate with each other, and one or more second electrical insulation layers, wherein the first electro-conductive layer and the second electrical insulation layer have a width and a length which are substantially coextensive therebetween, such that the main coil surfaces, which are substantially planar, include corresponding end surfaces of the first electro-conductive layer and the second electrical insulation layer, respectively, wherein at least two first electro-conductive layers have different average thicknesses to reduce an alternating current resistance of the coil by 5%-11.3% inclusive in a frequency of at least about 148 KHz.

In addition, there is provided a coil including a multilayer film which is wound to form a plurality of loops which are substantially concentric, wherein the multilayer film includes a plurality of first electro-conductive layers which are spaced apart from one another in a thickness direction, wherein at least two adjacent first electro-conductive layers include a second adhesive layer which is disposed between the two adjacent first electro-conductive layers, wherein at least one of the plurality of first electro-conductive layers is disposed on a third magnetic-conductive layer, wherein the first electro-conductive layer, the second adhesive layer, and the third magnetic-conductive layer have a width and a length which are substantially coextensive thereamong, such that main coil surfaces, which are substantially planar, include corresponding end surfaces of the first electro-conductive layer, the second adhesive layer, and the third magnetic-conductive layer, respectively, wherein the at least two first electro-conductive layers have different average thicknesses to reduce an alternating current resistance of the coil by 3%-6.6% inclusive in a frequency of at least about 143 kHz.

### Advantageous Effects

An embodiment of the disclosure has an effect that an alternating current resistance of a current is reduced.

In addition, there are effects that a small temperature increase is accompanied when wireless charging is performed, and a battery is charged more quickly.

### BRIEF DESCRIPTION OF THE DRAWINGS

FIG. 1 is a concept view of an electrical system according to a first embodiment of the disclosure;

FIG. 2 is a top view of a coil of FIG. 1:

FIG. 3 is a perspective view illustrating a multilayer film of FIG. 2 in part:

FIG. 4 is a top view of FIG. 3;

FIG. 5 is a cross-sectional view taken on line A-A′ of FIG. 2;

FIG. 6 is a graph illustrating comparison of alternating current resistance values between the coil according to the first embodiment of the disclosure, and comparison examples:

FIG. 7 is a view illustrating a state in which a multilayer film according to the first embodiment of the disclosure is wound around a rod:

FIG. 8 is a cross-sectional view taken on line B-B′ of FIG. 7:

FIG. 9 is a view illustrating a state in which the cross section of the rod of FIG. 8 is polygonal:

FIG. 10 is a sequence diagram illustrating a method of making a coil in sequence according to the first embodiment of the disclosure;

FIG. 11 is a partial cross-sectional view of a multilayer film according to a second embodiment of the disclosure:

FIG. 12 is a view illustrating a coil according to a third embodiment of the disclosure, and an enlarged view thereof; and

FIG. 13 is a partial perspective view illustrating a multilayer film according to a fourth embodiment of the disclosure.

### DETAILED DESCRIPTION

Hereinafter, specific embodiments for implementing the technical concept of the disclosure will be described in detail with reference to the accompanying drawings.

In the description of the disclosure, detailed explanations of related-art configurations or functions are omitted when it is deemed that they may unnecessarily obscure the essence of the disclosure.

In addition, it should be understood that, when a certain element is referred to as being “connected to,” “coupled to,” or “in contact with” another element, the certain element can be directly connected to, coupled to, or in contact with another element, but there may be an intervening element therebetween.

The terms used in the detailed descriptions are used for the purpose of describing particular embodiments only and are not intended to limit the disclosure. The singular forms include the plural forms as well unless the context clearly indicates otherwise.

In addition, in the detailed descriptions, the expressions “upper side surface,” “lower side surface,” etc. are described with reference to illustrations in the drawings, and it is to be noted that these may be expressed differently when the orientation of a corresponding object is changed. For the same reason, some element may be exaggerated, omitted or schematically illustrated in the drawings, and the size of each element does not entirely reflect a real size.

In addition, the terms including ordinal numbers such as ‘first’ and ‘second’ may be used to describe various elements, but these elements should not be limited by such terms. These terms are used for the purpose of distinguishing one element from another element only.

The terms “include,” “comprise” used in the detailed descriptions are used to specify a specific characteristic, area, integer, step, operation, element, and/or component, and do not preclude the presence or addition of other specific characteristics, areas, integers, steps, operations, elements, components, and/or groups.

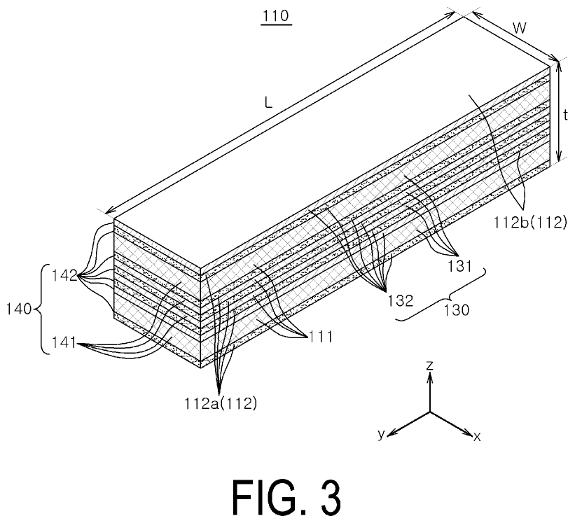

In the detailed descriptions, a width direction refers to an x-axis direction of FIG. 3, and a longitudinal direction refers to a y-axis direction of FIG. 3. In addition, a thickness direction refers to a z-axis direction of FIG. 3.

Hereinafter, a detailed configuration of an electrical system 1 according to a first embodiment of the disclosure will be described with reference to the drawings.

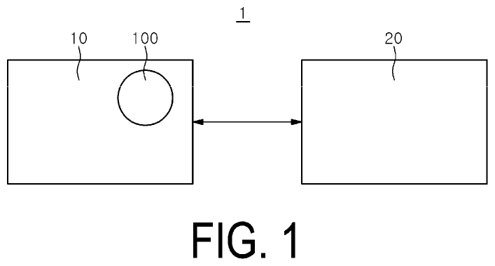

Referring to FIG. 1, the electrical system 1 according to the first embodiment of the disclosure may be installed in a portable electronic device like a smartphone, a PDA, a tablet, or the like, and may provide various functions. For example, the electrical system 1 may provide a wireless charging function (wireless power charging (WPC)) for wirelessly charging a battery, and may transmit and receive power through electromagnetic induction. In addition, the electrical system 1 may provide one or more functions of a short-range wireless communication system (near field communication (NFC)) and a wireless electronic payment system (magnetic secure transmission (MST)). The electrical system 1 may include a wireless charging system 10 and an electrical circuit 20.

The wireless charging system 10 may wirelessly supply power to the electrical circuit 20. In addition, the electrical circuit 20 may be configured to be charged wirelessly by the wireless charging system 10.

The wireless charging system 10 may include a coil 100 which is substantially planar.

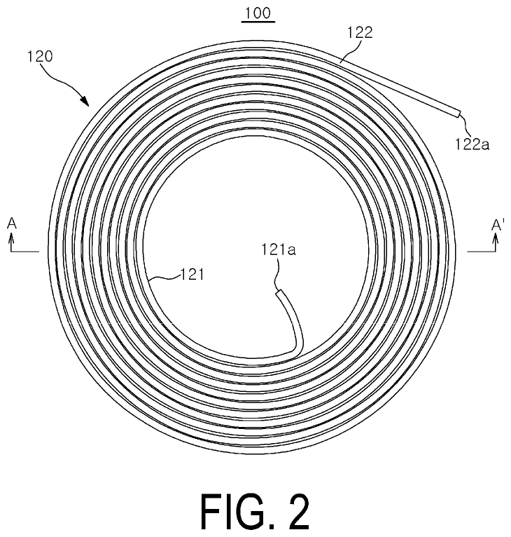

Referring to FIG. 2, the coil 100 may provide a portion through which a current flows. Such a coil 100 may include a multilayer film 110.

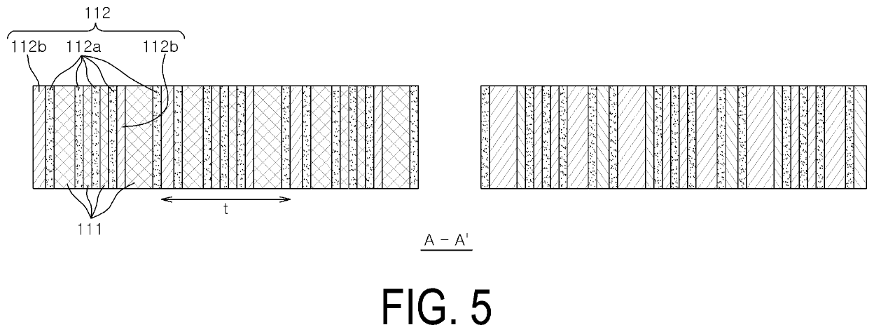

Referring to FIGS. 3 to 5, the multilayer film 110 may have a multilayer structure, and may include a conductive material through which a current flows. The multilayer film 110 may include a first electro-conductive layer 111 and a second electrical insulation layer 112.

The first electro-conductive layer 111 may include a metallic material enabling a current to flow therethrough. In addition, the first electro-conductive layer 111 may be magnetically insulative. The first electro-conductive layer 111 may be provided in plural number, and the plurality of first electro-conductive layers 111 may be arranged to alternate with one another. In addition, the plurality of first electro-conductive layer 111 may have different average thicknesses. For example, two or more first electro-conductive layers 111 may have different average thicknesses to reduce an alternating current resistance of the coil 100 by 5%-11.3% inclusive in a frequency of about 148 kHz or higher. In a more specific example, two or more first electro-conductive layers 111 may have different average thicknesses to reduce an alternating current resistance of the coil 100 by at least 5%, 6%, 7%, 8%, 9%, 10%, 11%, or 11.3% in a frequency of about 148 kHz or higher.

The second electrical insulation layer 112 may be disposed between the two adjacent first electro-conductive layers 111. In the detailed descriptions, the first electro-conductive layer 111 may include metal, and for example, may include copper.

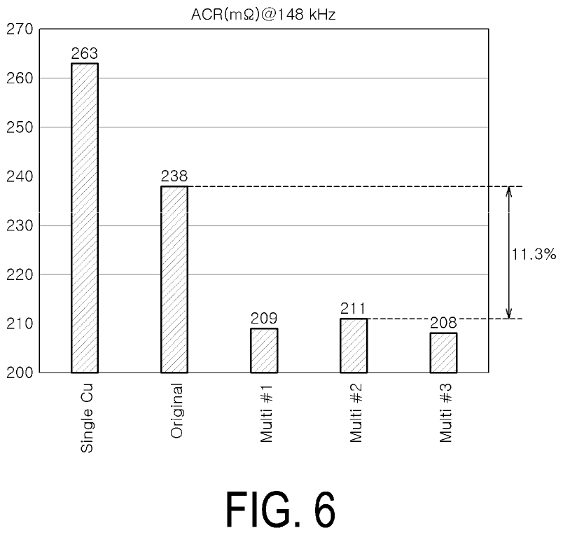

Referring to FIG. 6, the coil 100 according to the first embodiment of the disclosure may reduce the alternating current resistance by 11.3% compared to a related-art coil 100. Single copper which is a comparison example in FIG. 6 means that the multilayer film 100 is one copper layer, and uniform multi-copper indicates an alternating current resistance value when a plurality of copper layers have the same thickness. In addition, ununiform multi-copper #1 to #3 refer to three coils 100 in which a plurality of copper layers have different average thicknesses. That is, they refer to three different coils 100 according to the first embodiment.

The plurality of first electro-conductive layers 111 have different thicknesses as described above, such that an electric resistance value of the coil 100 is reduced and charging efficiency of the wireless charging system 10 is further enhanced.

One or more second electrical insulation layers 112 may be provided and may insulate between two adjacent first electro-conductive layers 111. The second electrical insulation layer 112 may include an adhesive layer 112a and a magnetic-conductive layer 112b. For example, at least one of the one or more second electrical insulation layers 112 may be the adhesive layer 112a. For example, at least one of the one or more second electrical insulation layers 112 may be the magnetic-conductive layer 112b.

The adhesive layer 112a may connect the first electro-conductive layer 111 and the magnetic-conductive layer 112b, and may connect two adjacent first electro-conductive layers 111. In addition, when the multilayer film 110 forms a loop 120 which will be described below, the adhesive layer 112a may connect between adjacent loops 120. The adhesive layer 112a described above may include, for example, an adhesive material.

The magnetic-conductive layer 112b may include a material having magnetism. The magnetic-conductive layer 112b may be connected with the first electro-conductive layer 111 through the adhesive layer 112a. The magnetic-conductive layer 112b may be provided in plural number. For example, any one of the plurality of magnetic-conductive layers 112b may be disposed between the first electro-conductive layer 111 and the adhesive layer 112a. In addition, another one of the plurality of magnetic-conductive layers 112b may be disposed on an outermost area of the multilayer film 110 in the thickness direction. When the multilayer film 110 forms the loop 120, the magnetic-conductive layer 112b disposed on the outermost area of the multilayer film 110 in the thickness direction may be connected with the adhesive layer 112a of an adjacent loop 120.

For example, the magnetic-conductive layer 112b may include one or more of a magnetic-conductive ferrite, a magnetic-conductive soft magnet, magnetic-conductive metal, a magnetic-conductive crystalline alloy, a magnetic-conductive nanocrystalline alloy, a magnetic-conductive amorphous alloy, and a magnetic-conductive composite.

In addition, the magnetic-conductive ferrite included in the magnetic-conductive layer 112b may include one or more of manganese-zinc ferrite and nickel-zinc ferrite.

In addition, the magnetic-conductive soft magnet included in the magnetic-conductive layer 112b may have coercivity of higher than 0 A/m and less than 1000 A/m. For example, the magnetic-conductive soft magnet may have coercivity of less than 1000 A/m or less than 100 A/m or less than 50 A/m or less than 20 A/m. In other words, the magnetic-conductive soft magnet included in the magnetic-conductive layer 112b may have coercivity of less than 20 A/m or may have coercivity of less than 1000 A/m.

In addition, the magnetic-conductive metal included in the magnetic-conductive layer 112b may include a magnetic-conductive alloy including iron. Herein, the magnetic-conductive alloy may include one or more of silicon, aluminum, boron, niobium, copper, cobalt, nickel and molybdenum.

In addition, the magnetic-conductive crystalline alloy included in the magnetic-conductive layer 112b may include two or more of iron, cobalt, and nickel.

In addition, the nanocrystalline alloy included in the magnetic-conductive layer 112b may include iron, silicon, boron, niobium, and copper.

In addition, the magnetic-conductive amorphous alloy included in the magnetic-conductive layer 112b may include one or more of silicon and boron and cobalt or iron.

In addition, the magnetic-conductive composite included in the magnetic-conductive layer 112b may include particles dispersed in a binder. Herein, the particles dispersed in the binder may include metallic particles, and for example, the metallic particles may include an iron-aluminum-silicon alloy.

Referring back to FIG. 2, the coil 100 may be wound to form a plurality of loops 120 which are substantially concentric. In other words, the multilayer film 110 may be provided to form the plurality of loops 120 by winding a long film of a linear shape multiple times. In the detailed descriptions, the plurality of loops 120 being formed means that the multilayer film 100 is wound multiple times to enclose a predetermined center. In addition, the plurality of loops 120 may be a concept that includes not only loops having different centers, but also a plurality of loops having the same center. In addition, the plurality of loops may be formed by separate coils, but may be formed in a connected shape by one coil. The plurality of loops 120 may include an innermost loop 121 and an outermost loop 122.

The innermost loop 121 may be a loop 120 that is disposed in the innermost area among the plurality of loops 120, and may include a first longitudinal direction end 121a which is an end at one side of the coil 100.

The outermost loop 122 may be a loop 120 that is disposed in the outermost area among the plurality of loops 120, and may include a second longitudinal direction end 122a which is an end at the other side of the coil 100.

Herein, the first longitudinal direction end 121a refers to an end at one side of the multilayer film 110 in the longitudinal direction, and the second longitudinal direction end 122a refers to an end at the other side of the multilayer film 110 in the longitudinal direction. In addition, the longitudinal direction may be a direction in which the multilayer film 110 is extended.

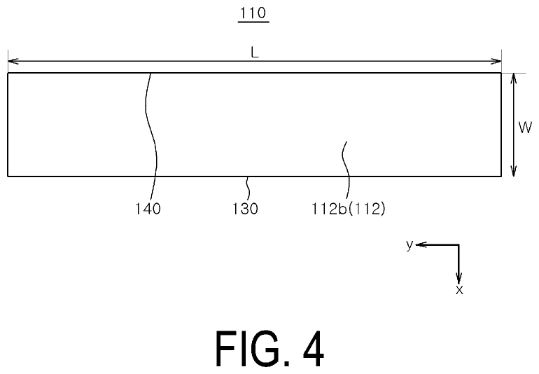

Referring to FIG. 4, the coil 100 may include main coil surfaces 130, 140. The main coil surfaces 130, 140 may be extended between the first longitudinal direction end 121a and the second longitudinal direction end 122a. In addition, the main coil surfaces 130, 140 may be opposite each other and may be substantially planar. The main coil surfaces 130, 140 may include a first main coil surface 130 which is one side surface of the multilayer film 110, and a second main coil surface 140 which is the other side surface of the multilayer film 110.

The first main coil surface 130 may include a first electro-conductive layer end surface 131 and a first electrical insulation layer end surface 132.

The second main coil surface 140 may include a second electro-conductive layer end surface 141 and a second electrical insulation layer end surface 142.

Herein, the first electro-conductive layer end surface 131 and the second electro-conductive layer end surface 141 refer to both side end surfaces of the first electro-conductive layer 111 in the width direction. In addition, the first electrical insulation layer end surface 132 and the second electrical insulation layer end surface 142 refer to both side end surfaces of the second electrical insulation layer 112 in the width direction.

In the detailed descriptions, the first electro-conductive layer end surface 131, the first electrical insulation layer end surface 132, the second electro-conductive layer end surface 141, the second electrical insulation layer end surface 142 may be referred to as corresponding end surfaces 131, 132, 141, 142. In addition, the main coil surfaces 130, 140 may include the corresponding end surfaces 131, 132, 141, 142.

In addition, the first electro-conductive layer 111 and the second electrical insulation layer 112 may have a width W and a length L which are substantially coextensive therebetween, such that the first main coil surface 130 and the second main coil surface 140, which are substantially planar, include the corresponding end surfaces 131, 132, 141, 142 of the first electro-conductive layer 111 and the second electrical insulation layer 112, respectively. In other words, the first electro-conductive layer 111 and the second electrical insulation layer 112 may be extended to have the same width W and the same length L.

As described above, the plurality of first electro-conductive layers 111 have different thicknesses, such that an electric resistance value of the coil 100 is reduced and charging efficiency of the wireless charging system 10 is further enhanced.

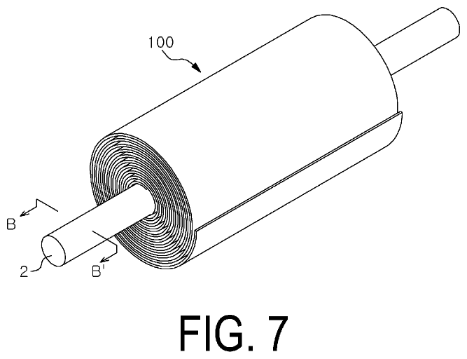

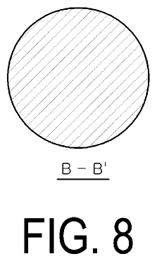

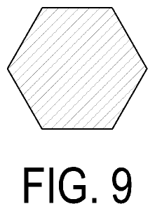

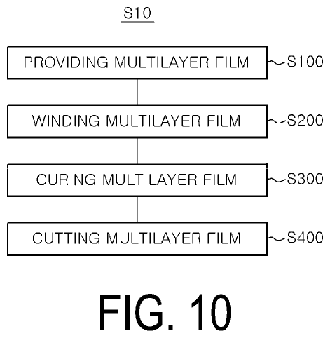

Hereinafter, a coil making method (S10) for making the coil 100 according to the first embodiment of the disclosure will be described with reference to FIGS. 7 to 10.

The coil making method (S10) may include a step of providing a multilayer film (S100), a step of winding the multilayer film (S200), a step of curing the multilayer film (S300), and a step of cutting the multilayer film (S400).

At the step of providing the multilayer film (S100), the multilayer film 110 including the plurality of first electro-conductive layers 111 which alternate with each other, and one or more second electrical insulation layers 112 may be provided.

At the step of winding the multilayer film (S200), the multilayer film 110 may be wound with reference to a longitudinal direction axis. In this case, the multilayer film 110 substantially having the center placed on the longitudinal direction axis may include turns which are substantially concentric. In addition, the multilayer film 110 may be wound around an elongated rod 2 which substantially has the center placed on the longitudinal direction axis. In the detailed descriptions, the turns mean that the multilayer film 110 is wound around the elongated rod 2 multiple times. In addition, it means that the plurality of turns have the same center. Herein, the elongated rod 2 may have a circular or polygonal cross section, and may be extended along the longitudinal direction axis.

At the step of curing the multilayer film (S300), the multilayer film 110 which is wound multiple times may be cured. At the step of curing the multilayer film (S300), a temperature and a time for curing the multilayer film 110 may vary according to a type of epoxy and a curing agent. For example, at the step of curing the multilayer film (S300), the multilayer film 110 wound around the elongated rod 2 may be cured by being exposed to a high temperature for a predetermined time, and the curing may be performed at a room temperature.

At the step of cutting the multilayer film (S400), the multilayer film 110 which is wound multiple times in order to form coils 100 may be cut in a direction substantially perpendicular to the longitudinal direction axis. In this case, the multilayer film 110 may be cut into a plurality of coils 100, and the coil 100 may include the plurality of loops 120 of the multilayer film 110 which are substantially concentric.

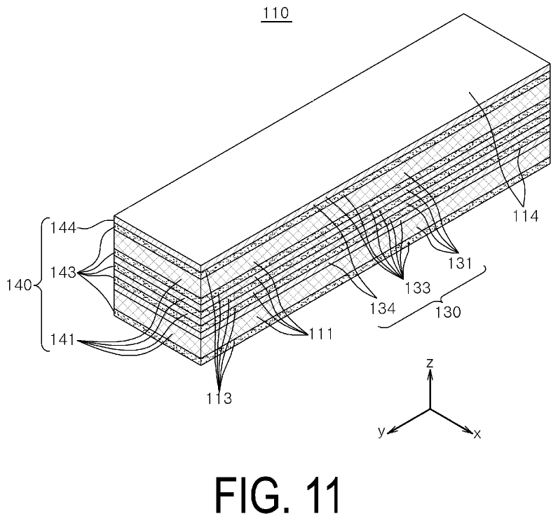

In addition to the above-described configurations, the multilayer film 110 according to a second embodiment of the disclosure may include a first electro-conductive layer 111, a second adhesive layer 113, and a third magnetic-conductive layer 114. Hereinafter, the second embodiment of the disclosure will be described by referring more to FIG. 11. In explaining the second embodiment, differences from the above-described embodiment will be highlighted, and, regarding the same explanation and reference numerals, the above-described embodiment is cited.

The multilayer film 110 may include the first electro-conductive layer 111, the second adhesive layer 113, and the third magnetic-conductive layer 114.

The first electro-conductive layer 111 may be provided in plural number, and the plurality of first electro-conductive layers 111 may have different average thicknesses. For example, two or more first electro-conductive layers 111 may have different average thicknesses to reduce an alternating current resistance of the coil 100 by 3%-6.6% inclusive in a frequency of about 143 kHz or higher. In a more specific example, two or more first electro-conductive layers 111 may have different average thicknesses to reduce an alternating current resistance of the coil 100 by at least 3%, 4%, 5%, 6%, or 6.6% in a frequency of about 148 KHz or higher.

The second adhesive layer 113 may connect the first electro-conductive layer 111 and the third magnetic-conductive layer 114. In addition, the second adhesive layer 113 may be disposed between at least two adjacent first electro-conductive layers 111 to connect the two adjacent first electro-conductive layers 111.

The third magnetic-conductive layer 114 may include a material having magnetism. In addition, at least one of the plurality of first electro-conductive layers 111 may be disposed on the third magnetic-conductive layer 114.

On the other hand, the first main coil surface 130 may include a first electro-conductive layer end surface 131, a first adhesive layer end surface 133, and a first magnetic-conductive layer end surface 134.

The second main coil surface 140 may include a second electro-conductive layer end surface 141, a second adhesive layer end surface 143, and a second magnetic-conductive layer end surface 144.

Herein, the first electro-conductive layer end surface 131 and the second electro-conductive layer end surface 141 refer to both side end surfaces of the first electro-conductive layer 111 in the width direction. In addition, the first adhesive layer end surface 133 and the second adhesive layer end surface 143 refer to both side end surfaces of the second adhesive layer 113 in the width direction. In addition, the first magnetic-conductive layer end surface 134 and the second magnetic-conductive layer end surface 144 refer to both side end surfaces of the third magnetic-conductive layer 114 in the width direction.

In addition, in the detailed descriptions, the first electro-conductive layer end surface 131, the first adhesive layer end surface 133, the first magnetic-conductive layer end surface 134, the second electro-conductive layer end surface 141, the second adhesive layer end surface 143, and the second magnetic-conductive layer end surface 144 may be referred to as corresponding end surfaces 131, 133, 134, 141, 143, 144. In addition, the main coil surfaces 130, 140 may include the corresponding end surfaces 131, 133, 134, 141, 143, 144.

In addition, the first electro-conductive layer 111, the second adhesive layer 113, and the third magnetic-conductive layer 114 may have a width W and a length L which are substantially coextensive thereamong, such that the first main coil surface 130 and the second main coil surface 140, which are substantially planar, include the corresponding end surfaces 131, 133, 134, 141, 143, 144, respectively. In other words, the first electro-conductive layer 111, the second adhesive layer 113, and the third magnetic-conductive layer 114 may be extended to have the same width W and the same length L.

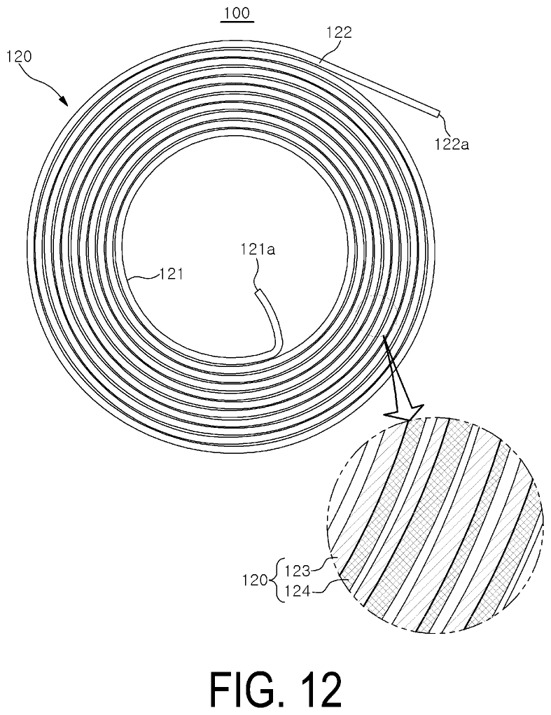

In addition to the configuration described above, the loop 120 according to a third embodiment of the disclosure may include a metal layer 123 and a nonmetal layer 124. Hereinafter, the third embodiment of the disclosure will be described by referring more to FIG. 12. In explaining the third embodiment, differences from the above-described embodiments will be highlighted, and, regarding the same explanation and reference numerals, the above-described embodiments are cited.

The coil 100 may include a plurality of loops 120 which are concentric. Each of the loops 120 which are concentric may includes a metal layer 123 and a nonmetal layer 124 which are substantially coextensive with the loop 120.

The metal layer 123 may include a metallic material through which a current flows. For example, the metal layer 123 may include copper. In addition, the metal layers 123 of the plurality of loops 120 may have different average thicknesses. For example, the metal layers 123 of two or more concentric loops 120 may have different average thicknesses to reduce a charging time spent by the wireless charging system 10 by 3%-6.6% inclusive in a frequency of about 143 kHz or higher. In a more specific example, the metal layers 123 of the two or more concentric loops 120 may have different average thicknesses to reduce a charging time spent by the wireless charging system 10 by at least 3%, 4%, 5%, 6%, 7%, 8%, or 8.5% in a frequency of about 143 kHz or higher.

The nonmetal layer 124 may connect adjacent metal layers 123. For example, the nonmetal layer 124 may include epoxy. The nonmetal layer 124 may face the metal layer 123 of an adjacent loop 120.

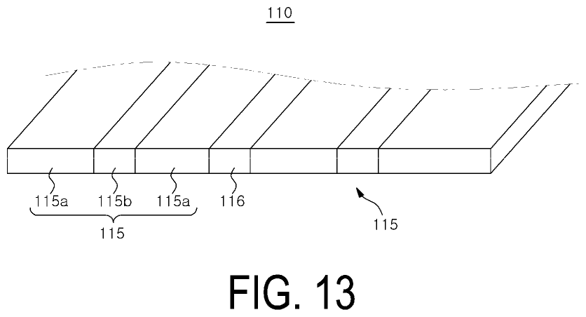

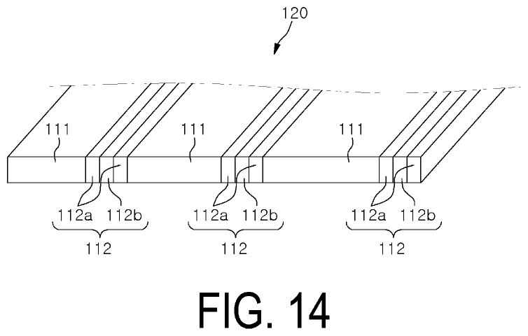

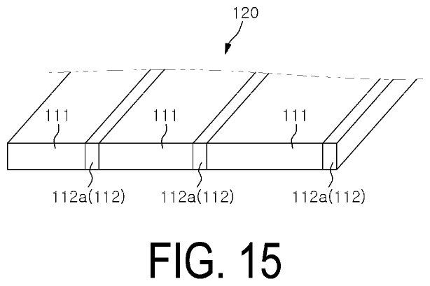

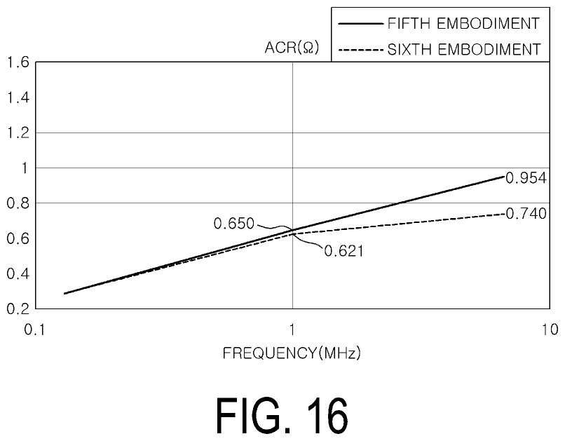

In addition to the configuration described above, the multilayer film 110 according to a fourth embodiment of the disclosure may include a mixture loop 115 and a mixture adhesive layer 116. Hereinafter, the fourth embodiment of the disclosure will be described by referring more to FIG. 13. In explaining the fourth embodiment, differences from the above-described embodiments will be highlighted, and, regarding the same explanation and reference numerals, the above-described embodiments are cited.

The mixture layer 115 may be provided in plural number, and the plurality of mixture layers 115 may be arranged on another in the thickness direction. For example, the mixture layer 115 may be referred to as a flexible copper clad laminate (FCCL) layer. The mixture layer 115 may include a mixture electro-conductive layer 115a and a connection layer 115b.

The mixture electro-conductive layer 115a may be provided in plural number, and the plurality of mixture electro-conductive layers 115a may be connected with each other by the connection layer 115b. For example, the mixture electro-conductive layer 115a may include copper.

The connection layer 115b may connect adjacent mixture electro-conductive layers 115a with each other. For example, the connection layer 115b may include polyimide (PI).

The mixture adhesive layer 116 may connect adjacent mixture layers 115 with each other.

As described above, the mixture electro-conductive layers 115a are connected with each other by the connection layer 115b, such that, when the coil 100 is cut, a surface of the coil 100 can be prevented from being shot in part by a burr or metal particles. In addition, the connection layer 115b is disposed between the mixture electro-conductive layers 115a, such that areas of the mixture electro-conductive layers 115a with respect to the same thickness increase.

In addition to the above-described configuration, the multilayer film 110 according to a fifth embodiment of the disclosure may include a first electro-conductive layer 111 and a second electrical insulation layer 112. Regarding the first electro-conductive layer 111 and the second electrical insulation layer 112 in the fifth embodiment, explanations in the first embodiment are cited.

Referring to FIG. 14, each of the plurality of loops 120 formed by winding the multilayer film 110 multiple times may include a first electro-conductive layer 111, an adhesive layer 112a, and a magnetic-conductive layer 112b. In other words, the multilayer film 110 in one loop 120 may include the first electro-conductive layer 111, the adhesive layer 112a, and the magnetic-conductive layer 112b as shown on the cross section of FIG. 14. Accordingly, the plurality of first electro-conductive layers 111 may be included in one loop 120, and the magnetic-conductive layer 112b may be disposed between the plurality of first electro-conductive layers 111 included in one loop 120.

Accordingly, an alternating current resistance of the coil 100 may be more reduced in a high frequency from a band of hundreds of kHz to a band of a few MHz, and charging efficiency of the wireless charging system 10 is further enhanced. Referring to table I presented below, a Q-factor value of the coil 100 according to the fifth embodiment has an effect of increasing by 24% compared to a Q-factor value of a sixth embodiment, which will be described below. Herein, the Q-factor value follows Equation 1 presented below:

$$Q ‐ factor = ( 2 π FL ) / R \qquad Equation 1$$

$$( F : Frequency , L : Inductance , R : Resistance )$$

TABLE 1

| | Q-factor |
|---|---|
| Fifth embodiment | 194 |
| Sixth embodiment | 156 |
| Increase or decrease | 24% |

In addition, referring to FIG. 16, there is an effect that the alternating current resistance of the coil 100 according to the fifth embodiment becomes lower than the alternating current resistance in the sixth embodiment in the same frequency.

However, FIG. 14 illustrates that the first electro-conductive layers 111 of each of the plurality of loops 120 have the same thickness, but the disclosure is not limited thereto, and thicknesses of the first electro-conductive layers 111 may be different from one another.

In addition to the above-described configuration, the multilayer film 110 according to the sixth embodiment of the disclosure may include a first electro-conductive layer 111 and an adhesive layer 112a. Regarding the first electro-conductive layer 111 and the adhesive layer 112a in the sixth embodiment, explanations in the first embodiment are cited.

Referring to FIG. 15, the first electro-conductive layer 111 may be configured to allow a current to flow therethrough. The first electro-conductive layer 111 may include a metallic material enabling a current to flow therethrough, and for example, may include copper. In addition, the first electro-conductive layer 111 may be provided in plural number.

The adhesive layer 112a may insulate between two adjacent first electro-conductive layers 111, and may bond between the two adjacent first electro-conductive layers 111. In addition, the adhesive layer 112a may be provided in plural number. In addition, the adhesive layer 112a may include an adhesive material, and for example, may include epoxy.

On the other hand, the plurality of first electro-conductive layers 111 and the plurality of adhesive layers 112a may be arranged alternately with each other in one loop 120.

The following is a list of embodiments of present disclosure.

Item 1 relates to a coil including: main coil surfaces which are opposite each other and are substantially planar; and a multilayer film which is wound to form a plurality of loops which are substantially concentric, wherein the plurality of loops include an innermost loop including a first longitudinal direction end of the coil, and an outermost loop including a second longitudinal direction end of the coil, wherein the multilayer film includes a plurality of first electro-conductive layers which alternate with each other, and one or more second electrical insulation layers, wherein the first electro-conductive layer and the second electrical insulation layer have a width and a length which are substantially coextensive therebetween, such that the main coil surfaces, which are substantially planar, include corresponding end surfaces of the first electro-conductive layer and the second electrical insulation layer, respectively, wherein two or more first electro-conductive layers have different average thicknesses to reduce an alternating current resistance of the coil by 5%-11.3% inclusive in a frequency of about 148 kHz or higher.

Item 2 relates to the coil, wherein at least one of the one or more second electrical insulation layers is an adhesive layer.

Item 3 relates to the coil, wherein at least one of the one or more second electrical insulation layers is a magnetic-conductive layer.

Item 4 relates to the coil, wherein the magnetic-conductive layer includes one or more of a magnetic-conductive ferrite, a magnetic-conductive soft magnet, magnetic-conductive metal, a magnetic-conductive crystalline alloy, a magnetic-conductive nanocrystalline alloy, a magnetic-conductive amorphous alloy, and a magnetic-conductive composite.

Item 5 relates to the coil, wherein the magnetic-conductive ferrite includes one or more of manganese-zinc ferrite and nickel-zinc ferrite.

Item 6 relates to the coil, wherein the magnetic-conductive soft magnet has coercivity of higher than 0 A/m and less than 1000 A/m.

Item 7 relates to the coil, wherein the magnetic-conductive metal includes a magnetic-conductive alloy including iron.

Item 8 relates to the coil, wherein the magnetic-conductive alloy further includes one or more of silicon, aluminum, boron, niobium, copper, cobalt, nickel and molybdenum.

Item 9 relates to the coil, wherein the magnetic-conductive alloy further includes one or more of silicon, boron, niobium, and copper.

Item 10 relates to the coil, wherein the magnetic-conductive crystalline alloy includes two or more of iron, cobalt, and nickel.

Item 11 relates to the coil, wherein the magnetic-conductive nanocrystalline alloy includes iron, silicon, boron, niobium, and copper.

Item 12 relates to the coil, wherein the magnetic-conductive amorphous alloy includes one or more of silicon and boron and one or more of cobalt and iron.

Item 13 relates to the coil, wherein the magnetic-conductive composite includes particles dispersed in a binder.

Item 14 relates to the coil, wherein the particles include metallic particles.

Item 15 relates to the coil, wherein the metallic particles include an iron-aluminum-silicon alloy.

Item 16 relates to the coil, wherein at least one of the one or more second electrical insulation layers includes an adhesive layer and a magnetic-conductive layer disposed on the adhesive layer.

Item 17 relates to the coil, wherein the first electro-conductive layer is magnetically insulative.

Item 18 relates to the coil, wherein the first electro-conductive layer includes metal.

Item 19 relates a coil including a multilayer film which is wound to form a plurality of loops which are substantially concentric, wherein the multilayer film includes a plurality of first electro-conductive layers which are spaced apart from one another in a thickness direction: a second adhesive layer which is disposed between two or more adjacent first electro-conductive layers; and
a third magnetic-conductive layer, wherein one or more of the plurality of first electro-conductive layers are disposed on the third magnetic-conductive layer, wherein the first electro-conductive layer, the second adhesive layer, and the third magnetic-conductive layer have a width and a length which are substantially coextensive thereamong, such that main coil surfaces, which are substantially planar, include corresponding end surfaces of the first electro-conductive layer, the second adhesive layer, and the third magnetic-conductive layer, respectively, wherein the two or more first electro-conductive layers have different average thicknesses to reduce an alternating current resistance of the coil by 3%-6.6% inclusive in a frequency of about 143 kHz or higher.

Item 20 relates to an electrical system including: a wireless charging system including a substantially planar coil which includes a plurality of loops which are concentric; and an electrical circuit configured to be charged wirelessly by the wireless charging system, wherein each of the concentric loops includes a metal layer which is substantially coextensive with the loop, wherein the metal layers of the two or more concentric loops have different average thicknesses to reduce a charging time spent by the wireless charging system by 3%-6.6% inclusive in a frequency of about 143 kHz or higher.

Item 21 relates to a method for making a coil, the method including: a step of providing a multilayer film which includes a plurality of first electro-conductive layers which alternate with one another, and one or more second electrical insulation layers: a step of winding the multilayer film with respect to a longitudinal direction axis in order to form a wound multilayer film, the multilayer film including a plurality of turns which are substantially concentric, the multilayer film substantially having a center placed on the longitudinal direction axis; and a step of cutting the wound multilayer film in a direction substantially perpendicular to the longitudinal direction axis, in order to form the coil, wherein the coil includes a plurality of loops of the multilayer film which are substantially concentric, wherein the loops include an innermost loop including a first longitudinal end of the coil, and an outermost loop including a second longitudinal end of the coil, wherein the coil includes main coil surfaces which are opposite each other and are substantially planar.

Item 22 relates to the coil making method, wherein the multilayer film is wound around an elongated rod which substantially has a center placed on the longitudinal direction axis.

Item 23 relates to the coil making method, wherein the elongated rod includes a substantially circular cross section.

Item 24 relates to the coil making method, wherein the elongated rod includes a substantially polygonal cross section.

Although embodiments of the disclosure have been described in the form of specific embodiments, these are merely examples and the disclosure is not limited thereto, and should be interpreted as having the widest scope of the technical concept disclosed in the specification. An ordinary skilled person in the related art may embody a pattern of a shape that is not set forth herein by combining/substituting the disclosed embodiments, without departing from the scope of the disclosure. In addition, an ordinary skilled person in the related art may easily change or modify the disclosed embodiments based on the detailed descriptions, and it is obvious that the changes or modifications belong to the right scope of the disclosure.

Description of Reference Numerals

| | |
|---|---|
| 1: electrical system | 2: rod |
| 10: wireless charging system | 20: electrical circuit |
| 100: coil | |
| 110: multilayer film | 111: first electro-conductive layer |
| 112: second electrical insulation layer | 112a: adhesive layer |
| 112b: magnetic-conductive layer | 113: second adhesive layer |
| 114: third magnetic-conduction layer | 115: mixture layer |
| 115a: mixture electro-conductive layer | 115b connection layer |
| 116: mixture adhesive layer | 120: loop |
| 121: innermost loop | 121a: first longitudinal direction end |
| 122: outermost loop | 122a second longitudinal direction end |
| 123: metal layer | 124: nonmetal layer |
| 130: first main coil surface | 131: first electro-conductive layer end surface |
| 132: first electrical insulation layer end surface | 133: first adhesive layer end surface |
| 134: first magnetic-conductive layer end surface | 140: second main coil surface |
| 141: second electro-conductive layer end surface | 142: second electrical insulation layer end surface |
| 143: second adhesive layer end surface | 144: second magnetic-conductive layer end surface |

1. A coil comprising:
main coil surfaces which are opposite each other and are substantially planar; and
a multilayer film which is wound to form a plurality of loops which are substantially concentric,
wherein the plurality of loops comprise an innermost loop comprising a first longitudinal direction end of the coil, and an outermost loop comprising a second longitudinal direction end of the coil,
wherein the multilayer film comprises
a plurality of first electro-conductive layers which alternate with each other, and one or more second electrical insulation layers,
wherein the first electro-conductive layer and the second electrical insulation layer have a width and a length which are substantially coextensive therebetween, such that the main coil surfaces, which are substantially planar, comprise corresponding end surfaces of the first electro-conductive layer and the second electrical insulation layer, respectively,
wherein two or more first electro-conductive layers have different average thicknesses to reduce an alternating current resistance of the coil by 5%-11.3% inclusive in a frequency of about 148 kHz or higher.

2. The coil of claim 1,
wherein at least one of the one or more second electrical insulation layers is a magnetic-conductive layer.

3. The coil of claim 2,
wherein the magnetic-conductive layer comprises
one or more of a magnetic-conductive ferrite, a magnetic-conductive soft magnet, magnetic-conductive metal, a magnetic-conductive crystalline alloy, a magnetic-conductive nanocrystalline alloy, a magnetic-conductive amorphous alloy, and a magnetic-conductive composite.

4. The coil of claim 3,
wherein the magnetic-conductive ferrite comprises one or more of manganese-zinc ferrite and nickel-zinc ferrite.

5. The coil of claim 3,
wherein the magnetic-conductive metal comprises a magnetic-conductive alloy comprising iron.

6. The coil of claim 1,
wherein one or more of the one or more second electrical insulation layers comprise an adhesive layer and a magnetic-conductive layer disposed on the adhesive layer.

7. The coil of claim 1,
wherein the first electro-conductive layer is magnetically insulative.

8. The coil of claim 1,
wherein the first electro-conductive layer comprises metal.

9. A coil comprising
a multilayer film which is wound to form a plurality of loops which are substantially concentric,
wherein the multilayer film comprises
a plurality of first electro-conductive layers which are spaced apart from one another in a thickness direction;
a second adhesive layer which is disposed between two or more adjacent first electro-conductive layers; and
a third magnetic-conductive layer,
wherein one or more of the plurality of first electro-conductive layers are disposed on the third magnetic-conductive layer,
wherein the first electro-conductive layer, the second adhesive layer, and the third magnetic-conductive layer have a width and a length which are substantially coextensive thereamong, such that main coil surfaces, which are substantially planar, comprise corresponding end surfaces of the first electro-conductive layer, the second adhesive layer, and the third magnetic-conductive layer, respectively,
wherein the two or more first electro-conductive layers have different average thicknesses to reduce an alternating current resistance of the coil by 3%-6.6% inclusive in a frequency of about 143 kHz or higher.

10. An electrical system comprising:
a wireless charging system comprising a substantially planar coil which comprises a plurality of loops which are concentric; and
an electrical circuit configured to be charged wirelessly by the wireless charging system,
wherein each of the concentric loops comprises a metal layer which is substantially coextensive with the loop,
wherein the metal layers of the two or more concentric loops have
different average thicknesses to reduce a charging time spent by the wireless charging system by 3%-6.6% inclusive in a frequency of about 143 kHz or higher.

11. The coil of claim 1, wherein at least one of the one or more second electrical insulation layers is an adhesive layer.

12. The coil of claim 3, wherein the magnetically conductive soft magnet has a coercivity of less than 1000 A/m.

13. The coil of claim 5, wherein the magnetic-conductive alloy further comprises one or more of silicon, aluminum, boron, niobium, copper, cobalt, nickel, and molybdenum.

14. The coil of claim 7, wherein the magnetic-conductive alloy further comprises one or more of silicon, boron, niobium, and copper.

15. The coil of claim 3, wherein the magnetic-conductive crystalline alloy comprises two or more of iron, cobalt and nickel.

16. The coil of claim 3, wherein the magnetic-conductive crystalline alloy comprises iron, silicon, boron, niobium, and copper.

17. The coil of claim 3, wherein the magnetic-conductive crystalline alloy comprises cobalt or iron, and one or more of silicon and boron.

18. The coil of claim 3, wherein the magnetic-conductive composite comprises particles dispersed in a binder.

19. The coil of claim 18, wherein the particles comprise metallic particles.

20. The coil of claim 19, wherein the metallic particles comprise an iron-aluminum-silicon alloy.
